(19) United States
(12) Patent Application Publication
(10) Pub. No.: US 2007/0087878 A1
(43) Pub. Date: Apr. 19, 2007

(54) Standard sprocket for chain

(75) Inventors: Takeshi Ogawa, Osaka (JP); Junya Kurohata, Osaka (JP); Shigenobu Sugasawa, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/517,214

(22) Filed: Sep. 7, 2006

(30) Foreign Application Priority Data
Oct. 13, 2005 (JP) 2005-299251

(51) Int. Cl. F16H 55/30; F16H 7/06; F16G 1/28

(52) U.S. Cl. 474/156; 474/152; 474/202

(57) ABSTRACT

In a chain transmission incorporating a standard roller chain, the diameter of the tooth gap bottom circle of a sprocket in mesh with the chain, is greater than the diameter of the tooth gap bottom circle for a corresponding sprocket having an ISO tooth form.

### CROSS-REFERENCE TO RELATED APPLICATION

This application claims priority on the basis of Japanese application 2005-299251, filed Oct. 13, 2005. The disclosure of Japanese application 2005-299251 is hereby incorporated by reference.

### FIELD OF THE INVENTION

This invention relates to chain transmission, and particularly to sprocket which reduces the noise generated when a standard chain, such as a roller chain or a bushing chain, engages with the sprocket.

### BACKGROUND OF THE INVENTION

A chain transmission in which a chain transmits power from a crankshaft sprocket to one or more camshaft sprockets has been widely used as a valve timing drive in vehicle engines.

In recent years, due to environmental problems, there has been an increasing demand for high combustion efficiency in vehicle engines. This demand has resulted in the development of engines that have increased power for a given engine size. In such engines, the load on the timing transmission has increased, with a resulting increase in the level of sprocket-engagement noise generated in the timing transmission.

Because engine manufacturers must satisfy severe noise level requirements, various noise reduction measures have been taken. Vibration proof materials have been applied to engines in order to absorb sounds that would otherwise be radiated. For example, vibration proof rubber has been used to reduce noise and vibration. However, vibration proof materials, by themselves, have been unable to control the engagement noise generated when the load on a timing transmission, and chain tension, are increased.

Roller chains and sprockets used in chain transmissions are defined in International Standard (ISO 606: 1994(E)) and in Japanese Industrial Standards (JIS B 1801-1997). The International Standard (ISO 606: 1994 (E)) defines tooth forms of chains and sprockets (the “ISO tooth form”), and Japanese Industrial Standards (JIS B 1801-1997) define tooth forms of chains and sprockets (S-tooth forms and U-tooth forms). Both International Standard (ISO 606: 1994(E)) and Japanese Industrial Standards (JIS B 1801-1997) are here incorporated by reference.

As used herein, the term “standard chain” means a chain as defined in International Standard ISO 606: 1994 (E), or in Japanese Industrial Standards JIS B 1801-1997, and the term “standard tooth form” means the ISO tooth form, the S-tooth form, or the U-tooth form according to the above-mentioned Japanese Industrial Standards.

A standard roller chain 51, and a standard sprocket 1 having an ISO tooth form, will be described with reference to FIGS. 8 and 9. The ISO tooth form is defined by the following expressions from ISO 606: 1994 (E):
d=p/sin (180°/z)
d_{f}=d−dₗ
rₑ(max)=0.12 dₗ(z+2)
rₗ(min)=0.505dₗ
rₑ(min)=0.008dₗ(z²+180)
rₗ(max)=0.505dₗ+0.069(dₗ)^{1/3}
where

p is the chain pitch,

d is the pitch circle diameter,

dₗis the roller outer diameter,

rᵢ is the radius of the arc of the tooth gap bottom

rₑ is the tooth surface radius,

d_{f} is the diameter of the tooth gap bottom circle (root diameter), and

z is the number of sprocket teeth.

The Japanese Industrial Standard tooth form differs in some respects from the ISO tooth form. However, the root diameter, d_{f}=d−dₗ, is the same in both cases. In FIG. 8, the distance pa is the chordal pitch of the sprocket, which, in the case of a sprocket having the standard tooth form, is equal to the chain pitch p.

As apparent from the above expressions, in the ISO tooth form shown in FIG. 8, the profile of the tooth gap bottom 3 is in the form of an arc having a radius rᵢ, which is slightly larger than the radius (dₗ/2) of the roller 52, and the tooth surface 2 is in the form of an arc having a radius rₑ. Tooth surfaces 2 are continuous with the tooth gap bottom portion 3 on both sides of the tooth gap. As is apparent from the above expressions, the diameter d_{f} of the tooth gap bottom circle (also referred to as the “root diameter”) is equal to the difference between the pitch circle diameter d and the roller outer diameter dₗ. Furthermore, the diameter d_{f} of the tooth gap bottom circle is substantially the same as the difference between the pitch circle diameter d and twice the arc radius rᵢ of the tooth gap bottom.

To reduce the noise generated when a chain engages with a sprocket, a low noise vibration sprocket has been proposed in which impact-absorbing rings are disposed at the circumference of the sprocket on both sides of the sprocket teeth. The impact-absorbing ring overlaps the link plates of the chain in the vicinity of the tooth gap bottoms of the sprocket, but does not interfere with the link plates in a region other than the vicinity of the tooth gap bottoms, as the chain moves around the sprocket. This low noise vibration sprocket is described in Japanese Laid-Open Patent Publication No. Hei 11-2312

Another proposal of reducing noise in a roller chain transmission is to provide a roller with an outer diameter larger than the standard size so that the roller engages the opposed surfaces of a pair of adjacent teeth while there is a clearance between the roller and a tooth gap bottom, and in which the arc of the tooth gap bottom has a diameter slightly smaller than the outer diameter of the roller and an angle formed by a line tangent to the roller at a position where the roller abuts a sprocket tooth and a line connecting the center of the roller and the center of the sprocket is such that the roller seats on the tooth gap bottom or can come into sliding contact with a tooth surface and move to the vicinity of the tooth gap bottom while the roller and/or the tooth surface deform elastically. This approach to noise reduction is described in Japanese Patent Publication No. Hei 7-18478

Chain transmissions generally use standard roller chains and standard sprockets, defined in ISO 606: 1994 (E) or JIS B 1801-1997.

The engagement between a standard sprocket 1 and a standard roller chain 51 having an ISO tooth form will be explained with reference to FIG. 9. In this case, the standard sprocket 1 is used as an idler in an engine timing transmission. When tension is applied to the chain 51 by rotation of a crankshaft, rollers 52 of the chain sequentially engage tooth gaps of the sprocket as the sprocket rotates counterclockwise. When the standard sprocket 1 rotates counterclockwise, a roller 52b moves relatively about the center o1 of a preceding roller 52a which is already seated and supported in a tooth gap. The center of the roller 52b moves relative to the center of the preceding roller 52a in an arc having a radius corresponding to the chain pitch p, until the roller 52b collides with a tooth gap bottom 3. Since the chordal pitch pₐ of the standard sprocket 1 and the chain pitch p of the standard roller chain 51 are equal, roller 52b collides with the tooth gap bottom, in the vicinity of the center of the arc of the tooth gap bottom, substantially at a right angle. The impact of the collision of the roller 52b with the tooth gap bottom 3 generates large amounts of noise in the case of a standard sprocket and a standard roller chain.

FIG. 10 is a graph showing a vibration waveform in a case of a standard sprocket having the ISO tooth form and a standard roller chain used in a an engine timing chain transmission. As shown in FIG. 10, a vibration of large magnitude occurs, and this vibration results of the generation of a large amount of noise.

An impact absorbing ring, as disclosed in Japanese Laid-Open patent Publication No. Hei 11-2312, can reduce the noise produced as a result of vibration. However, when an impact-absorbing ring is used, the production cost of the chain transmission becomes significantly higher.

In the low noise chain transmission disclosed in Japanese patent Publication No. Hei 7-18478, the angle formed by a line tangent to the point at which the roller abuts a tooth surface of the sprocket and a line connecting the center of the roller and the center of the sprocket is a small angle such that the roller comes into sliding contact with the tooth surface and seats on the tooth gap bottom as the roller and/or the tooth surface deform elastically. Thus, the impact of engagement between the roller and the tooth surface of the sprocket is alleviated, and engagement noise is reduced. However, since the roller becomes sandwiched between opposed tooth surfaces, it does not smoothly disengage from the sprocket on the disengagement side.

Accordingly, an object of the invention is to provide an improved tooth form for a sprocket for use with a standard chain, such that engagement noise is reduced and smooth disengagement can take place, without significantly increasing production cost.

### SUMMARY OF THE INVENTION

In the chain transmission according to the invention a standard chain having a series of sprocket tooth-engaging elements, such as rollers, pins or bushings, is in meshing relationship with a sprocket having a plurality of teeth and tooth gaps between successive teeth. The sprocket tooth-engaging elements of the chain enter the tooth gaps of the sprocket, the teeth on both sides of each tooth gap have facing tooth surfaces continuous with the tooth gap bottom of the tooth gap between them, and the root diameter of the sprocket is larger than the root diameter of a standard tooth form on a sprocket having the same number of sprocket teeth and designed to mesh with the same standard chain.

Since the root diameter of the sprocket is larger than the root diameter of a standard tooth form, the chordal pitch of the sprocket becomes larger than the chain pitch of the standard chain. Accordingly, a sprocket tooth-engaging element of the standard chain first abuts a rear tooth surface at the start of engagement along a direction substantially tangent to the rear tooth surface. Consequently, impact is small, and the noise due to the impact is reduced.

On the disengagement side of the sprocket, a preceding tooth-engaging element pivots about the center of the next element in an arc having a radius corresponding to the chain pitch. On the disengagement side, the tooth-engaging element only abuts a front tooth surface and easily pivots away from the sprocket about the center of the next tooth-engaging element. Therefore, disengagement can take place more smoothly than in the case of a low noise chain transmission where the roller is sandwiched between opposed tooth surfaces.

With the invention, impact noises can be reduced simply by improving the sprocket tooth form. The process of making a sprocket according to the invention is essentially the same as the process of making a conventional sprocket having a standard tooth form. Therefore, the sprocket of the invention can be made without a significant increase in production cost, and uniform quality can be achieved.

### BRIEF DESCRIPTION OF THE DRAWINGS

FIG. 1 is an elevational view of a sprocket according to a first embodiment of the invention, showing the tooth form;

FIG. 2 is an elevational view of a sprocket according to a second embodiment of the invention, showing the tooth form;

FIG. 3 is an elevational view of a sprocket according to a third embodiment of the invention, showing the tooth form;

FIG. 4 is an elevational view of a sprocket according to a fourth embodiment of the invention, showing the tooth form;

FIG. 5 is a schematic elevational view showing a sprocket according to any one of the above-mentioned embodiments, used in an engine valve timing chain transmission;

FIG. 6 is a graph illustrating the relationship between the rotational speed and the vibration level for a sprocket according to the invention, a sprocket having an ISO tooth form, and a comparative example;

FIG. 7 is a graph illustrating a vibration waveform in the case of a sprocket according to the invention when engaged with a standard roller chain;

FIG. 8 is an elevational view of a sprocket having an ISO tooth form;

FIG. 9 is a schematic elevational view showing a standard sprocket having the ISO tooth form shown in FIG. 8 and a standard roller chain used in an engine valve timing chain transmission; and

FIG. 10 is a graph illustrating a vibration waveform in the case of a standard sprocket having an ISO tooth form, when engaged with a standard roller chain;

### DETAILED DESCRIPTION OF THE PREFERRED EMBODIMENTS

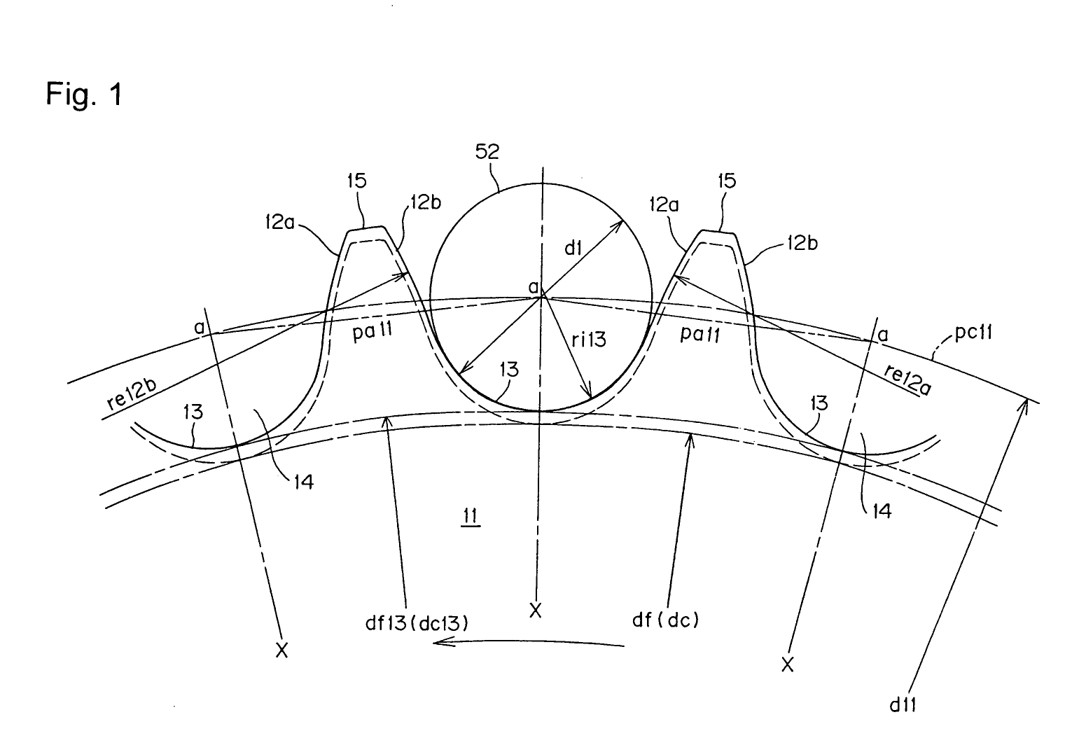

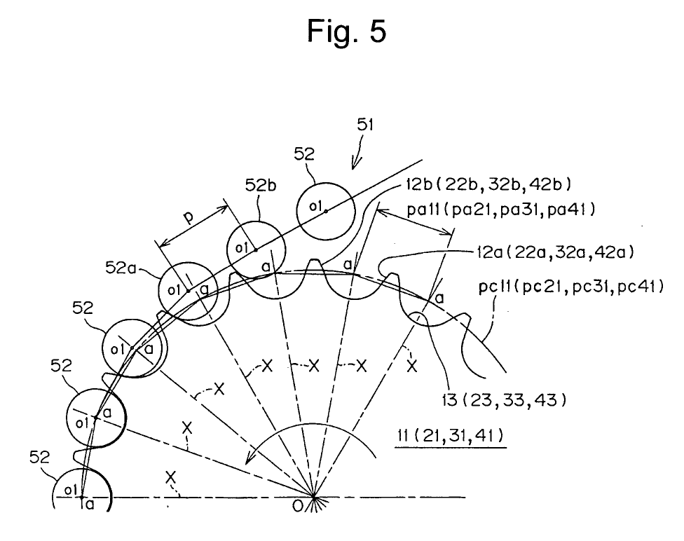

The best mode of a sprocket according to the invention is illustrated in FIG. 1. The sprocket 11 includes a plurality of teeth 15, formed by cutting tooth gaps 14. The facing tooth surfaces 12a and 12b are continuous with the tooth gap bottoms 13. As shown in FIG. 5, a standard roller chain 51 engages the tooth gaps.

In FIG. 1, an ISO tooth form is shown by a broken line for purposes of comparison with the tooth form of the invention, shown as a continuous line. The root diameter d_{f}13 (FIG. 1), which is the diameter of a circle tangent to the tooth gap bottoms, is larger than the root diameter d_{f} of an ISO tooth form in a standard sprocket, having the same number of teeth, and designed to be used with the chain 51.

Several examples of chain transmissions according to the invention will be described below with reference to FIGS. 1-4.

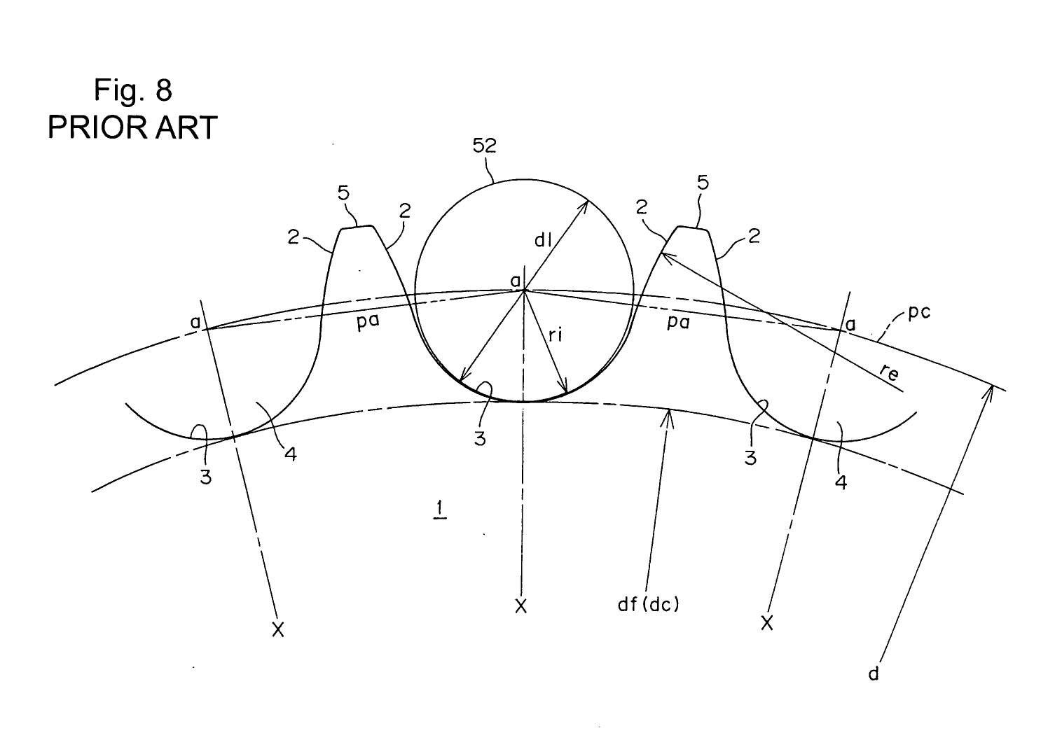

The tooth form of the sprocket 11 is formed as shown in FIG. 1 such that a front tooth surface 12a (in the rotational direction of the sprocket) and a rear tooth surface 12b are symmetrical with respect to the tooth gap center line x, which connects the rotational center O (FIG. 5) of the sprocket 11 and the center of the tooth gap bottom 13. The tooth surfaces 12a and 12b are in the form of convex arcs, having equal radii, re12a and re12b, respectively. These radii are larger than the radius rₑ (FIG. 8) of the arc-shaped tooth surface of the ISO tooth form. In other words, rₑ12a>rₑ and rₑ12b>rₑ. The tooth surfaces 12a and 12b are smoothly continuous with the tooth gap bottom 13. That is, the tooth surfaces meet the tooth gap bottoms without any sharp angles and without any curvature having a radius substantially less than the radius of curvature rᵢ13 of the tooth gap bottom, the tooth gap bottom being in the form of an arc having its center on the tooth gap bottom center line x. The radius of curvature ri13 of the tooth gap bottom is larger than the radius rᵢ of an arc-shaped tooth gap bottom of the ISO tooth form of a sprocket designed for the same chain. That is, rᵢ13>rᵢ.

As shown in FIG. 1, the center of the radius ri13 lies on the center line x, and is positioned outward (from the center of the sprocket) relative to the center of radius ri of the tooth gap bottom of the ISO tooth form. Since the center of the arc of the tooth gap bottom is positioned outward relative to the center of the arc of the tooth gap bottom of the ISO tooth form, the root diameter d_{f}13 is greater than the root diameter d_{f} of the ISO tooth form. The root diameter is readily measured in the case of sprockets having even numbers of teeth. In the case of a sprocket having an odd number of teeth, a quantity known as “caliper diameter” (d_{c}), can be used. The caliper diameter is determined by measuring the distance between the centers of pins disposed in tooth gaps that are most nearly opposite each other. In the case of a sprocket according to the invention, having an odd number of teeth, the caliper diameter d_{c}13 is larger than a caliper diameter d_{c} of the ISO tooth form in a corresponding conventional sprocket. That is, d_{c}13>d_{c}.

In FIG. 1, the chordal pitch pₐ 11 of the sprocket 11 according to the invention is the distance between points a of intersection of the pitch circle pc11 and center lines x of tooth gap bottoms. Likewise, as shown in FIG. 8, the chordal pitch pₐ in the standard sprocket 1 having the ISO tooth form, is the distance between points a of intersection of the pitch circle pc and center lines x of tooth gap bottoms. Since the diameter d_{f}13 of the tooth gap bottom circle is larger than the diameter d_{f} of the tooth gap bottom circle of the ISO tooth form (or the caliper diameter d_{c}13 is greater than the caliper diameter d_{c} of the ISO tooth form in the case of a sprocket having an odd number of teeth), the chordal pitch pₐ11 of the sprocket 11 is larger than the chordal pitch pₐ of a standard sprocket. That is, pₐ11>pₐ.

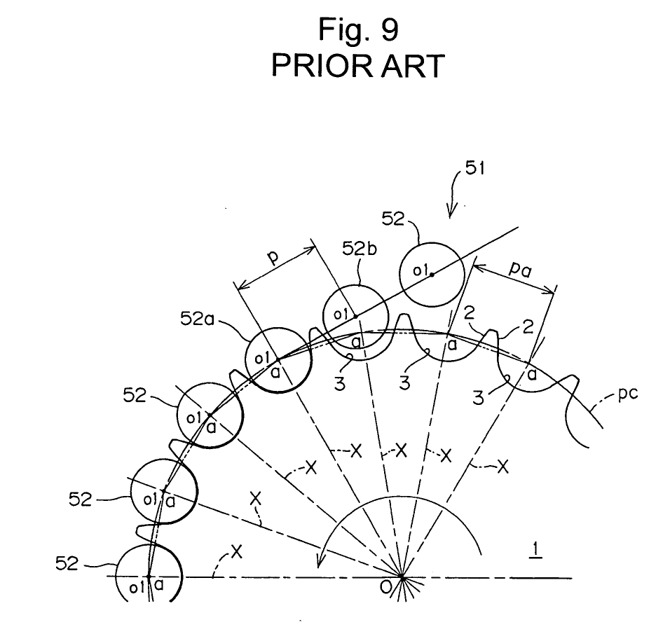

The chordal pitch pₐ of the sprocket having the ISO tooth form is equal to a chain pitch p (that is, the distance between centers o1 of the rollers 52 of the standard roller chain 51 shown in FIG. 9). On the other hand, the chordal pitch pₐ 11 of the sprocket 11 (FIG. 1) is larger than the chain pitch p of the standard roller chain 51, shown in FIG. 5. That is, pₐ11>p.

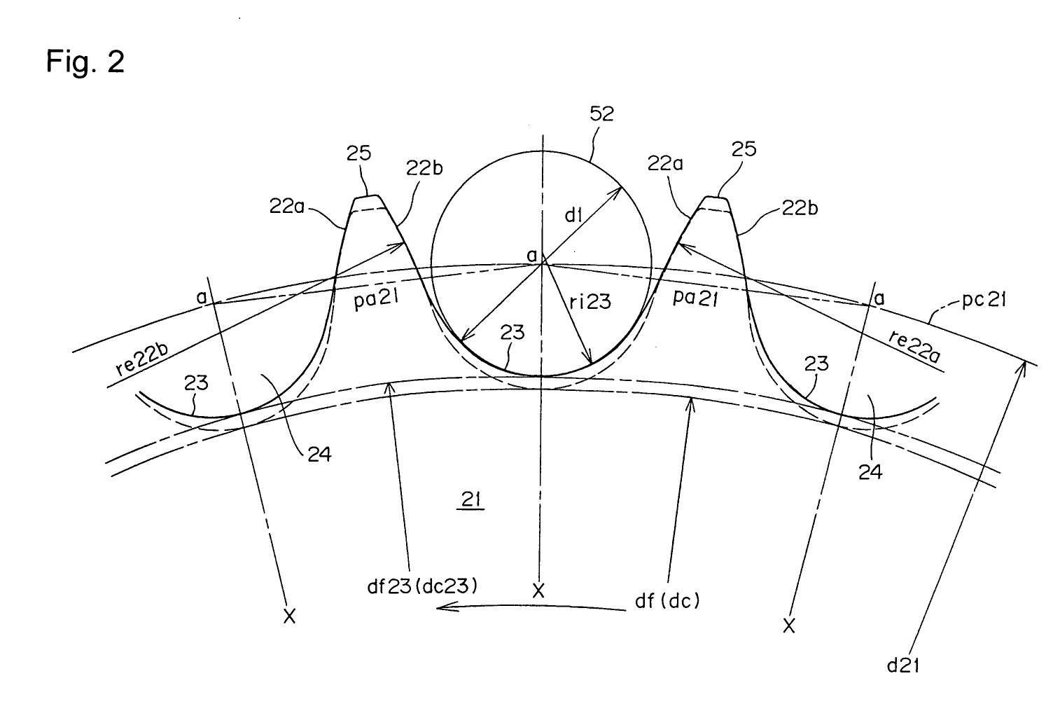

In the second embodiment of the invention, shown in FIG. 2, sprocket 21 has a tooth form different from that of the sprocket of FIG. 1, but is also adapted to a standard roller chain 51. In sprocket 21, teeth 25 are formed by tooth gaps 24, and facing tooth surfaces 22a and 22b are continuous with the tooth gap bottoms 23. In FIG. 2, as in FIG. 1, the ISO tooth form is shown by a broken line.

The facing front and rear tooth surfaces 22a and 22b are symmetrical with respect to a center line x of the tooth gap bottom 23 between them. The tooth surfaces 22a and 22b are respectively in the form of convex arcs having radii re22a and re22b respectively. These radii are the same as the radius rₑ of the arc-shaped tooth surfaces of the ISO tooth form, as shown in FIG. 8. That is, rₑ22a=rₑ and rₑ22b=re. The tooth surfaces 22a and 22b are smoothly continuous with the tooth gap bottom 23.

The tooth gap bottom 23 is in the form of an arc having its center on the tooth gap bottom center line x. The radius rᵢ23 of the arc of the tooth gap bottom 23 is greater than the radius rᵢ (FIG. 8) of the tooth gap bottom of the ISO tooth form. That is, ri23>rᵢ.

The center of the arc of the tooth gap bottom 23 is positioned outward relative to the center of the arc of the tooth gap bottom of the ISO tooth form. Since the center of the arc of tooth gap bottom 23 is positioned outward relative to the center of the arc of the tooth gap bottom of the ISO tooth form, the diameter d_{f}23 of the tooth gap bottom circle is larger than the diameter d_{f} of a tooth gap bottom circle of the ISO tooth form. That is, d_{f}23>d_{f}. In the case of a sprocket having an odd number of teeth, the caliper diameter d_{c}23 is also larger than the caliper diameter d_{c} of the ISO tooth form. That is, d_{c}23>d_{c}.

In this embodiment, as in the first embodiment, the chordal pitch pₐ21 of the sprocket 21 (that is, the distance between points a of intersection of the pitch circle pc21 and center lines x of tooth gap bottoms) is larger than the chordal pitch pₐ of the sprocket 1 having the ISO tooth form. That is, pₐ21>pₐ.

As in the first embodiment, the chordal pitch pₐ21 of the sprocket 21 is also greater than the chain pitch p of the standard roller chain 51. That is, pₐ21>p.

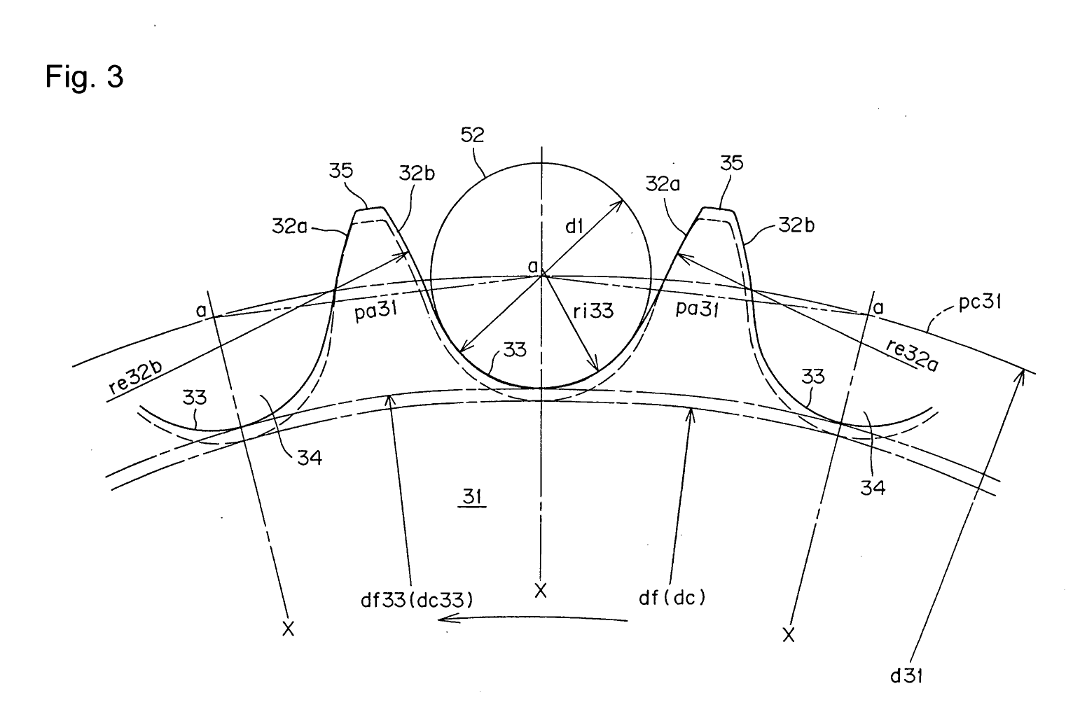

In the third embodiment of the invention, shown in FIG. 3, sprocket 31 has a tooth form different from that of the sprockets of FIGS. 1 and 2, but is also adapted to a standard roller chain 51. In sprocket 31, teeth 35 are formed by tooth gaps 34, and facing tooth surfaces 32a and 32b are continuous with the tooth gap bottoms 33. In FIG. 3, as in FIGS. 1 and 2, an ISO tooth form is shown by a broken line.

In sprocket 31, as shown in FIG. 3, the front tooth surface 32a and the rear tooth surface 32b are asymmetrical with respect to the center line x of the tooth gap bottom 33. Tooth surface 32ₐ is in the form of a convex arc having a radius re32a, which is the same as the radius rₑ of the tooth surface of the ISO tooth form. That is, rₑ32a=rₑ. On the other hand, the tooth surface 32b is in the form of a convex arc having a radius rₑ32b, which is larger than the radius rₑ of the tooth surface of the ISO tooth form. That is, rₑ32b>rₑ. Both tooth surfaces 32a and 32b are smoothly continuous with the tooth gap bottom 33.

The tooth gap bottom 33 is in the form of an arc having its center on the tooth gap bottom center line x. The radius rᵢ33 of the arc of the tooth gap bottom 33 is greater than the radius rᵢ (FIG. 8) of the tooth gap bottom of the ISO tooth form. That is, rᵢ33>rᵢ.

The center of the arc of the tooth gap bottom 33 is positioned outward relative to the center of the arc of the tooth gap bottom of the ISO tooth form. Since the center of the arc of tooth gap bottom 33 is positioned outward relative to the center of the arc of the tooth gap bottom of the ISO tooth form, the diameter d_{f}33 of the tooth gap bottom circle is larger than the diameter d_{f} of a tooth gap bottom circle of the ISO tooth form. That is, d_{f}33>d_{f}. In the case of a sprocket having an odd number of teeth, the caliper diameter d_{c}33 is also larger than the caliper diameter d_{c} of the ISO tooth form. That is, d_{c}33>d_{c}.

In this embodiment, as in the first and second embodiments, the chordal pitch pₐ31 of the sprocket 31 (that is, the distance between points a of intersection of the pitch circle pc31 and center lines x of tooth gap bottoms) is larger than the chordal pitch pₐ of the sprocket 1 having the ISO tooth form. That is, pₐ31>pₐ.

As in the first and second embodiments, the chordal pitch pₐ31 of the sprocket 31 is also greater than the chain pitch p of the standard roller chain 51. That is, pₐ31>p.

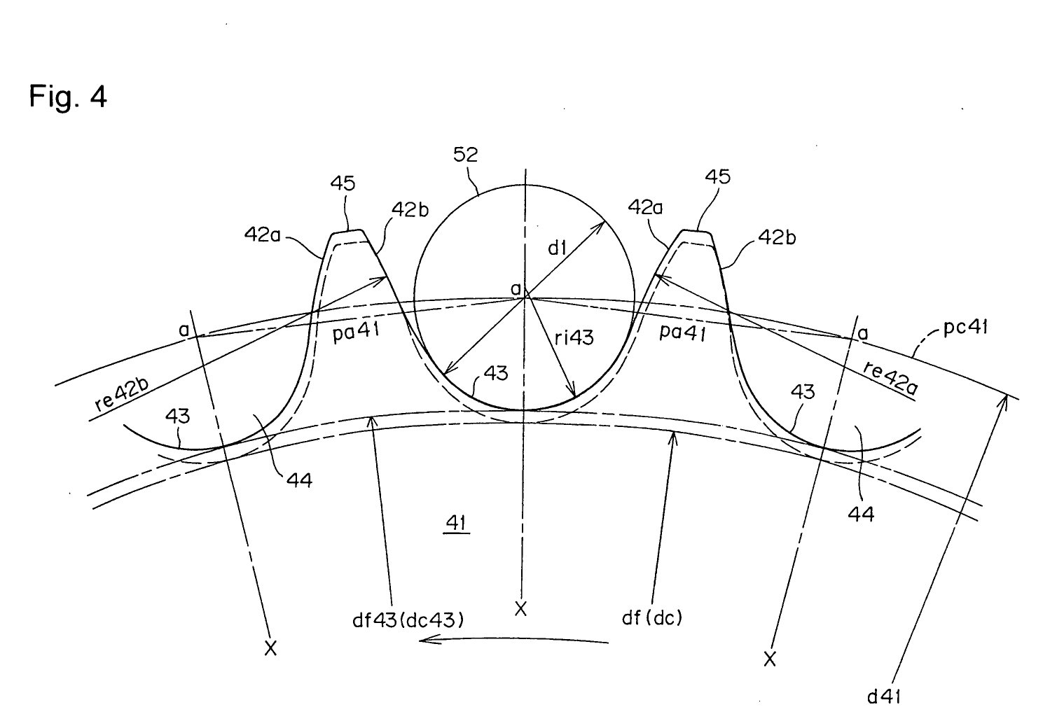

In the fourth embodiment of the invention, shown in FIG. 4, sprocket 41 has a tooth form different from that of the sprockets of FIGS. 1, 2 and 3, but is also adapted to a standard roller chain 51. In sprocket 41, teeth 45 are formed by tooth gaps 44, and facing tooth surfaces 42a and 42b are continuous with the tooth gap bottoms 43. In FIG. 4, as in FIGS. 1, 2 and 3, an ISO tooth form is shown by a broken line.

The front and rear tooth surfaces 42a and 42b are asymmetrical with respect to the center line x of the tooth gap bottom 43. The tooth surface 42a is in the form of a convex arc having a radius rₑ42a, which is greater than the radius rₑ of the arc-shaped tooth surface of the ISO tooth form. That is, rₑ42a>rₑ. On the other hand, tooth surface 42b is in the form of an arc having a radius re42b which is the same as radius rₑ of the arc-shaped tooth surface of the ISO tooth form. That is, rₑ42b=rₑ. Both tooth surfaces 42a and 42b are smoothly continuous with the tooth gap bottom 43. The tooth gap bottom 43 is in the form of an arc having its center on the tooth gap bottom center line x. The radius rᵢ43 of the arc of the tooth gap bottom 43 is greater than the radius rᵢ (FIG. 8) of the tooth gap bottom of the ISO tooth form. That is, rᵢ43>rᵢ.

The center of the arc of the tooth gap bottom 43 is positioned outward relative to the center of the arc of the tooth gap bottom of the ISO tooth form. Since the center of the arc of tooth gap bottom 43 is positioned outward relative to the center of the arc of the tooth gap bottom of the ISO tooth form, the diameter d_{f}43 of the tooth gap bottom circle is larger than the diameter d_{f} of a tooth gap bottom circle of the ISO tooth form. That is, d_{f}43>d_{f}. In the case of a sprocket having an odd number of teeth, the caliper diameter d_{c}43 is also larger than the caliper diameter d_{c} of the ISO tooth form. That is, d_{c}43>d_{c}.

In this embodiment, as in the first, second and third embodiments, the chordal pitch pₐ41 of the sprocket r41 (that is, the distance between points a of intersection of the pitch circle pₐ41 and center lines x of tooth gap bottoms) is larger than the chordal pitch pₐ of the sprocket 1 having the ISO tooth form. That is, pₐ41>pₐ.

As in the first, second and third embodiments, the chordal pitch pₐ41 of the sprocket 41 is also greater than the chain pitch p of the standard roller chain 51. That is, pₐ41>p.

The engagement of the above-mentioned sprockets 11, 21, 31 and 41 with a standard roller chain 51 is depicted in FIG. 5. The sprockets 11, 21, 31 and 41, in this case, are used as idlers in an engine timing drive in which rotation is transmitted from a crankshaft to one or more camshafts. Engagement between the standard roller chain and the sprocket takes place in the same manner for each of the four embodiments.

When tension is applied to the standard roller chain 51 by the rotation of the crankshaft, the rollers sequentially engage the tooth gaps of the sprocket so that the sprocket 11 is rotated in counterclockwise. As the chain approaches the sprocket, a following roller 52b pivots relative to a preceding roller 52a which is already seated and supported in a tooth gap. The following roller 52b pivots about the center o1 of the preceding roller 52a, moving relative to roller 52a in an arc having a radius equal to the chain pitch p. Because the chordal pitch (e.g., pₐ11 in FIG. 1) of the sprocket is larger than the chain pitch p, the following roller 52b abuts a rear tooth surface (e.g., surface 12b in FIG. 1). The following roller 52b approaches abutment with the rear tooth surface in a direction substantially tangential to the tooth surface 12b. Consequently, the impact on engagement of a roller with the sprocket is small, and noise due to the impact is reduced. As the sprocket rotates, the point at which the roller 52b engages the tooth gap gradually moves toward the tooth gap bottom. The roller rolls noiselessly on the tooth gap surface is it moves toward the tooth gap bottom.

Because the chordal pitch of the sprocket is greater than the chain pitch, as each roller of the chain continues to move around the sprocket, the point of engagement of the roller with the tooth gap gradually moves from the tooth gap bottom to the front face of the tooth on the rear side of the tooth gap. The roller then disengages from the sprocket by pivoting in an arc having a radius equal to the chain pitch, about the center of the next following roller. Since the roller, when it is about to disengage the sprocket, is only engaged with a front tooth surface, it can easily and smoothly separate from the sprocket.

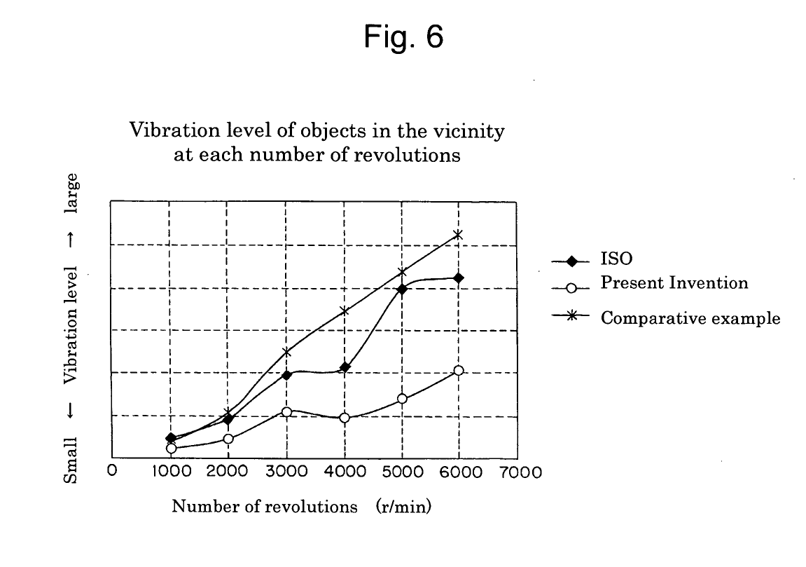

The graph of FIG. 6 shows the relationship between the rotational speed of the sprocket (in revolutions per minute) and the vibration level in an engine timing chain transmission. FIG. 6 shows the vibration levels for a sprocket according to the invention, a sprocket having an ISO tooth form, and another sprocket (a comparative example) in which the tooth gap bottom circle has a diameter smaller than that of the tooth gap bottom circle in an ISO tooth form. In the case of the sprocket having the ISO tooth form, and the comparative example, the vibration level increases significantly with increasing rotational speed. However, with the sprocket according to the invention, although the vibration level increases somewhat with increasing rotational speed, the rate of increase is much less than the rate of increase for the ISO tooth form sprocket and the comparative sprocket.

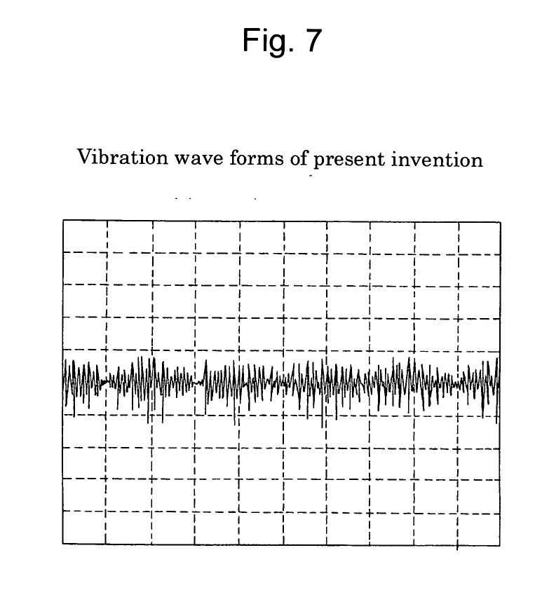

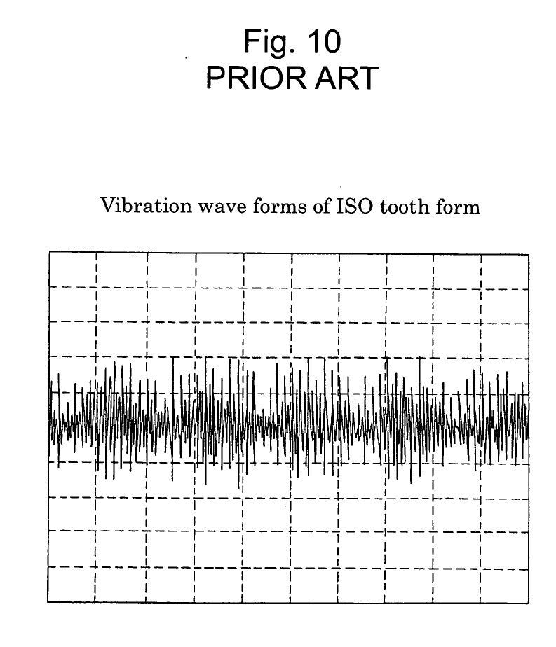

FIG. 7 is shows a typical vibration waveform for a sprocket according to the invention, used with a standard roller chain. The magnitude of the vibrations is small compared to the magnitude of the vibrations in FIG. 10.

In summary, in accordance with the invention, the diameter (d_{f}13, d_{f}23, d_{f}33, or d_{f}44) of the tooth gap bottom circle, is larger than the diameter d_{f} of the tooth gap bottom circle of a sprocket having the ISO tooth form adapted for use with the same standard roller chain. The chordal pitch (pₐ11, pₐ21, pₐ31, pₐ41) of the sprocket is larger than the chain pitch p of the standard roller chain. Thus, at the start of engagement of a chain roller with the sprocket, the roller first abuts a rear tooth surface (12b, 22b, 32b, or 42b), approaching the rear tooth surface substantially tangentially, thereby reducing impact. Because of the reduced impact, noise due to impact is reduced.

Furthermore on disengagement of a roller from the sprocket a preceding roller pivots about the center of following roller used as a center in an arc having a radius equal to the chain pitch. Since the preceding roller 52a is only in engagement with a front tooth surface at the time of disengagement from the sprocket, it is more smoothly separated from the sprocket than in the case of a conventional low noise chain transmission.

Since the sprocket can be produced by a method corresponding to the method used to produce a sprocket having the ISO tooth form, and does not require a special part such as an impact absorbing ring, its production cost is not significantly increased. Additionally since no impact absorbing ring is needed, the sprocket can be easily produced with consistent good quality.

Although a transmission using a standard roller chain has been described, the invention can incorporate other forms of transmission chains having sprocket tooth-engaging elements other than rollers. For example the advantages of the invention can be realized in a transmission utilizing a standard bushing chain.

What is claimed is:

1. A chain transmission comprising a standard chain having a series of sprocket tooth-engaging elements, and a sprocket having a plurality of teeth and tooth gaps between successive teeth, wherein the chain is in meshing relationship with the sprocket and the sprocket tooth-engaging elements of the chain enter the tooth gaps of the sprocket, each tooth gap has a tooth gap bottom, the teeth on both sides of each tooth gap have facing tooth surfaces continuous with the tooth gap bottom of the tooth gap between them, and the root diameter of the sprocket is larger than the root diameter of a standard tooth form on a sprocket having the same number of sprocket teeth and designed to mesh with the same standard chain.
